(19) United States
(12) Patent Application Publication
(10) Pub. No.: US 2009/0146933 A1
(43) Pub. Date: Jun. 11, 2009

(54) HIGH CONTRAST LIQUID CRYSTAL DISPLAY DEVICE

(75) Inventors: Hugo Matthieu Visser, Eindhoven (NL); Mark Thomas Johnson, Eindhoven (NL); Nebojsa Fisekovic, Eindhoven (NL); Antonius Hendricus Maria Holtslag, Eindhoven (NL); Wilbert L. Ijzerman, Eindhoven (NL); Johannes Josephus Wilhelmus Maria Rosink, Eindhoven (NL); Dmitri Chestakov, Eindhoven (NL); Ramon Pascal Van Gorkom, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,765

(22) PCT Filed: Nov. 24, 2005
(86) PCT No.: PCT/IB05/53894

§ 371 Date: May 21, 2007

(30) Foreign Application Priority Data
Nov. 24, 2004 (EP) 04106048.4

(51) Int. Cl. G09G 3/36

(52) U.S. Cl. 345/87

(57) ABSTRACT

A liquid crystal display comprising first and second liquid crystal display panel (1, 3), each defining an array of picture elements (13, 15). The resolution of the image displayed on the second liquid crystal display panel (3) is lower than that of the image displayed on the first liquid crystal display panel (1). The picture elements (15) of the second liquid crystal display panel (3), located between the first liquid crystal display panel (1) and backlighting means (2) may be relatively large and preferably partially overlap at least in one direction. A charge is selectively applied to the picture elements (15) of the second liquid crystal display panel (3) corresponding to the relatively darker portions of the image to be displayed on the first liquid crystal panel (1), so as to at least limit the amount of light reaching these portions of the first liquid crystal display panel (1) and thereby increasing the contrast trio of the device. In an alternative embodiment, the image displayed on the second liquid crystal display panel (3) may be blurred relative to the image displayed on the first liquid crystal display panel (1) and/or the image displayed on the first liquid crystal display panel (1) may be sharpened relative to the image displayed on the second liquid crystal display panel (3).

This invention relates generally to a liquid crystal display and, more particularly, to a liquid crystal display having a relatively high brightness and contrast.

A liquid crystal display (LCD) generally comprises a plurality of picture elements (pixels) arranged in rows and columns. The operation of a liquid crystal display is based on light modulation in a liquid crystal (LC) cell including an active layer of a liquid crystal material. By applying an electric field over the liquid crystal layer, the polarization of the light passing this layer is modified. In LCD displays, this effect is used to control the light from individual pixel elements. To this end, the LC layer is sandwiched in between two polarizers.

Conventional liquid crystal displays have unique advantages compared with other types of displays, including thin form factor and high resolution, but in general they suffer from the rather serious drawback of rather low brightness and low contrast, especially for larger viewing angles (i.e. further off the display normal).

Although LCD displays are already being used in hospitals for many applications, it is recognized that especially for demanding applications like X-ray, the current LCD image quality is inferior to conventional X-ray films. First of all, the peak brightness used in X-ray film viewing is typically 3000 nits, whereas current LCD monitors have about 500 nits peak brightness. Secondly, the contrast of LCD displays is lower, ranging from 500 to 1000 at normal viewing angles to only 10 at larger viewing angles (say 70 degrees off-normal). It is the object of this invention to improve LCD displays on these to aspects.

U.S. Pat. No. 4,927,240 describes a multilayer liquid crystal display comprising at least two liquid crystal layers and at least three polarizers, so as to improve the overall contrast of the display: the contrast which can be obtained is that of the first liquid crystal layer multiplied by that of the second liquid crystal layer, provided that the required electrodes, spacers, separating transparent sheets and polarizers are employed.

However, in the arrangement described in U.S. Pat. No. 4,927,240, the number of pixels in both the first and second liquid crystal layers is the same and, because the density of pixels required for applications such as medical imaging and television/multi-media applications is so high, the duplication of the first liquid crystal layer is relatively costly, as is the requirement to provide the above-mentioned respective electrodes, spacers, separating transparent sheets and polarizers. Furthermore, the peak brightness of the display suffers from the limited aperture of the pixels of the 2^{nd} LCD.

It is therefore an object of the present invention to address the problems outlined above, and to provide a liquid crystal display having increased contrast and brightness relative to prior art arrangements.

In accordance with a first aspect of the present invention, there is provided a system for displaying an image on a liquid crystal display comprising a first liquid crystal display panel defining an array of picture elements for displaying an image, backlighting means, and a second liquid crystal display panel located between said first liquid crystal display panel and said backlighting means, said second liquid crystal display panel defining an array of picture elements for displaying an image, the system being arranged and configured to display at least a portion of said image on each of said first and second liquid crystal display panels such that the resolution of the image displayed on said second liquid crystal display panel being lower than that of the image displayed on said first liquid crystal display panel.

Also in accordance with the first aspect of the present invention, there is provided a liquid crystal display comprising a first liquid crystal display panel defining an array of picture elements for displaying an image, backlighting means, a second liquid crystal display panel defining an array of picture elements for displaying an image, and a system according to claim 1.

Still further in accordance with the first aspect of the present invention, there is provided a method for displaying an image as a liquid crystal display comprising a first liquid crystal display panel defining an array of picture elements for displaying an image, backlighting means, and a second liquid crystal display panel located between said first liquid crystal display panel and said backlighting means, said second liquid crystal display panel defining an array of picture elements for displaying an image, the method comprising displaying at least a portion of said image on each of said first and second liquid crystal display panels such that the reduction of the image displayed on said second liquid crystal display panel is lower than that of the image displayed on said first liquid crystal display panel.

The additional (second) liquid crystal layer that displays at least a portion of the image at a lower resolution than that of the first liquid crystal layer reduces the brightness level of the dark portions of the image displayed on the LCD panel. As a result, the dynamic range of the liquid crystal display is increased relative to the prior art. An enhanced output power of the backlight (relative to conventional backlight means), e.g. of the order of 500-1000 nits increases the brightness value of the bright portions of the displayed image, thereby further increasing the dynamic range of the liquid crystal display.

Beneficially, adjacent respective polarizers of the first and second liquid crystal display panels are aligned. This involves aligning the front polarizer of the back (second) liquid crystal display panel and the back polarization of the front (first) liquid crystal display panel (which are facing each other). Since the polarizer on each separate panel are oriented vertically and horizontally, the backpanel should be mirrored with respect to the frontpanel to achieve this objective in the event that substantially similar (or identical) liquid crystal panels are used for the first and second liquid crystal display panels. As is known to a person skilled in the art, the panels can also be oriented diagonally, the main point being that they should be aligned.

Thus, in a preferred embodiment, means are provided to divide the image such that a first portion of the image is displayed on the first liquid crystal display panel and a second portion of the image is displayed on the second liquid crystal display panel.

Thus, the original image content is preferably distributed across the two panels which, as a result, yield a very high contrast (the product of the contrast ratio of the individual panels) and, moreover, yield an increased bit depth. Standard, single panel LCD screens can typically display 8 bits of information. For medical applications, more and more LCD manufacturers have started to produce 10 bit panels. However, original X-ray data (for example), as measured with, for instance, mammography X-ray detectors, already contain 14 to 16 bit information and, in accordance with an exemplary embodiment of the present invention, it would be possible to display nearly all of these different grey levels.

In a first exemplary embodiment, the image displayed on the second liquid crystal display panel is blurred relative to that displayed on the first liquid crystal display panel. Blurring across a range of about 5 pixels (1-2 mm) is thought to be adequate without destroying the high resolution demands of applications such as mammography. Beneficially, the image displayed on the first liquid crystal display panel is sharpened relative to that displayed on the second liquid crystal display panel. As a result, the “perceived” image displayed by the dual layer LCD corresponds to the original image.

The above-mentioned blurring may be achieved by means of one of a number of known blurring algorithms, as will be apparent to a person skilled in the art of image processing. The required blurring could also be achieved by removing the front polarizer of the second (back) liquid crystal display panel and replacing it with diffusing means, such as a thin diffusion foil. A relatively complex blurring algorithm would then be unnecessary.

The first and second liquid crystal display panels should be placed as close together as possible to avoid or minimize parallax effects or a 3D impression. Another exemplary embodiment which would minimize parallax uses very thin glass (or other cover layer).

In an exemplary embodiment, means may be provided for selectively applying a charge to one or more of the picture elements of said second liquid crystal display panel corresponding to relatively dark portions of, said image, so as to at least limit the quantity of light transmitted there through to said first liquid crystal display panel.

However, in a preferred embodiment, the second (back)panel does not only serve as a light modulator, but also contains image information.

In fact, in accordance with a second aspect of the present invention, there is provided a liquid crystal display wherein the electrodes in respect of the picture elements of at least the second liquid crystal display panel are of a zig-zag or otherwise meandering configuration.

In a preferred embodiment, adjacent picture elements of said second liquid display panel at least partially overlap. More preferably, neighboring first and second picture elements are interwoven in an overlap area so as to create a gradual transition therebetween. As a result, the visibility in the displayed image of the edges of neighboring picture elements of the second liquid crystal display panel due to parallax is at least reduced. In one exemplary embodiment, the gradual transition between said first and second neighboring picture elements is in the form of a plurality, preferably substantially triangular, comb teeth.

Beneficially, a charge is selectively applied to the picture elements of said first and/or second liquid crystal display panels via respective electrodes, wherein the electrodes in respect of the picture elements of at least the second liquid crystal display panel are preferably of a zig-zag or otherwise meandering configuration, so as to reduce visibility thereof.

The present invention extends to a method of manufacturing a liquid crystal display as defined above, and an apparatus and method of driving such a liquid crystal display.

Also in accordance with the second aspect of the present invention, there is provided a liquid crystal display comprising a first liquid crystal display panel defining an array of picture elements for displaying an image, and backlighting means, the display further comprising a second liquid crystal display panel located between said first liquid crystal display panel and said backlighting means, said second liquid crystal display panel defining an array of fewer and larger picture elements than that of said first liquid crystal display panel, and means for selectively applying a charge to one or more of the picture elements of said second liquid crystal display panel corresponding to relatively dark portions of said image, so as to at least limit the quantity of light transmitted therethrough to said first liquid crystal display panel.

Apart from the increased contrast, another great benefit is the very good viewing angle. At normal incidence the contrast is bout 500000:1 (700:1 for a standard monitor), whereas at 80° off-axis, the contrast is still 3000:1 (50:1 for a standard monitor). In a hospital environment/reading room, this is of great value, since often three to four doctors are watching the screen at the same time from several angles to discuss an X-ray image. With a standard LCD monitor this is difficult due to glare and reflections at oblique angles. Also the contrast at high viewing angles is very low, whereas with the present invention this is no longer an issue.

In order to reach the high brightness demanded by some applications, it is necessary to boost the backlight as well. With each subsequent greyscale LCD panel, about 50% of the light is thrown away. Therefore, we use high brightness backlights, where the number of lamps are doubled For color panels, an extra light reduction is caused by the color filters (±60% loss). Even more lamps are then required to reach the demanded brightness.

These and other aspects of the present invention will be apparent from, and elucidated with reference to, the embodiments described herein.

Embodiments of the present invention will now be described by way of examples only and with reference to the accompanying drawings, in which:

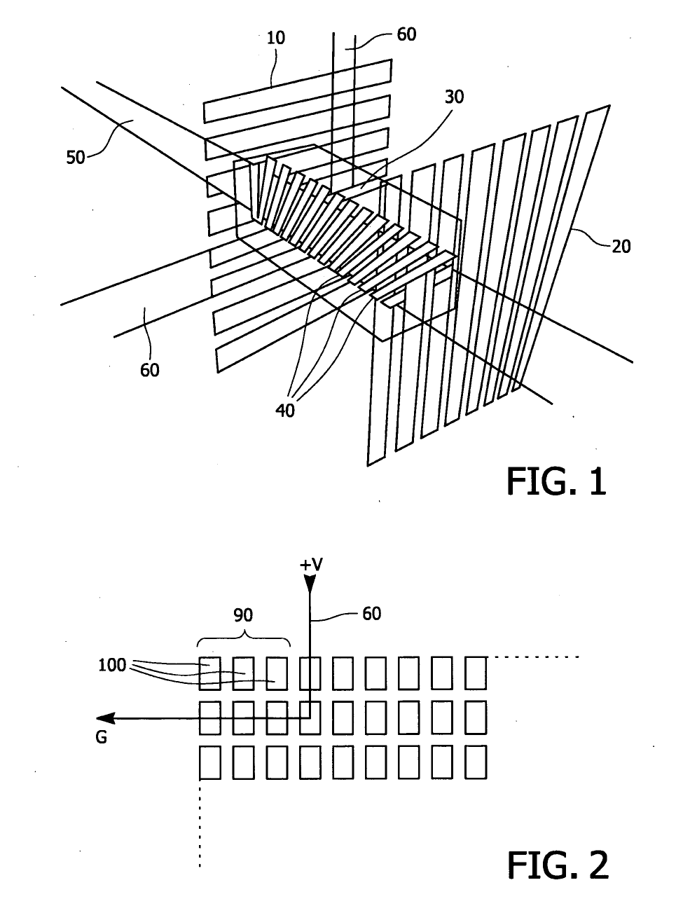

FIG. 1 is a schematic diagram illustrating the principle of operation of a liquid crystal display;

FIG. 2 is a schematic diagram illustrating the manner in which the pixels of a color LCD are controlled;

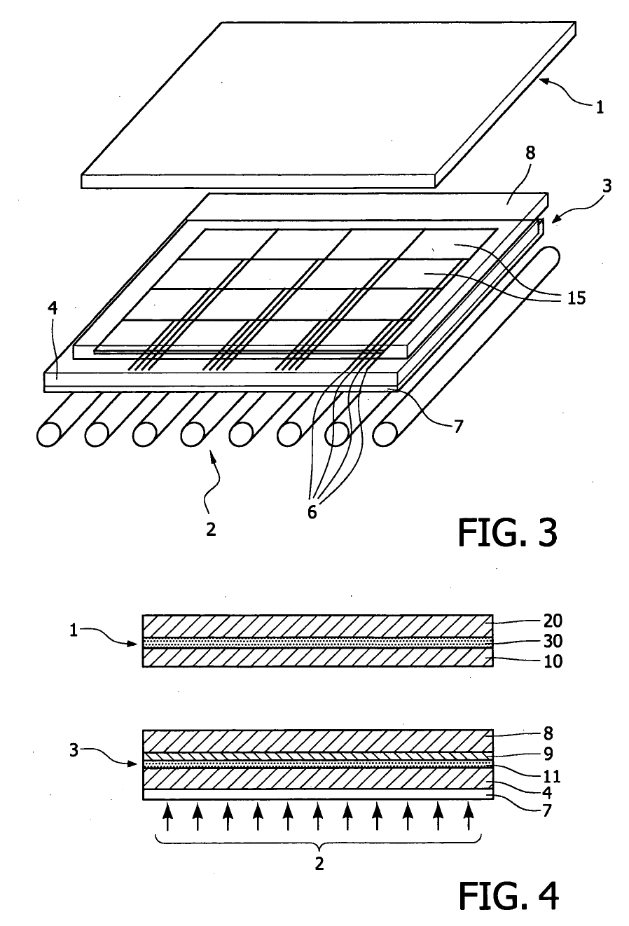

FIG. 3 is a schematic diagram illustrating the structure of a liquid crystal display according to an exemplary embodiment of the present invention;

FIG. 4 is a schematic cross-sectional view of the structure of FIG. 3;

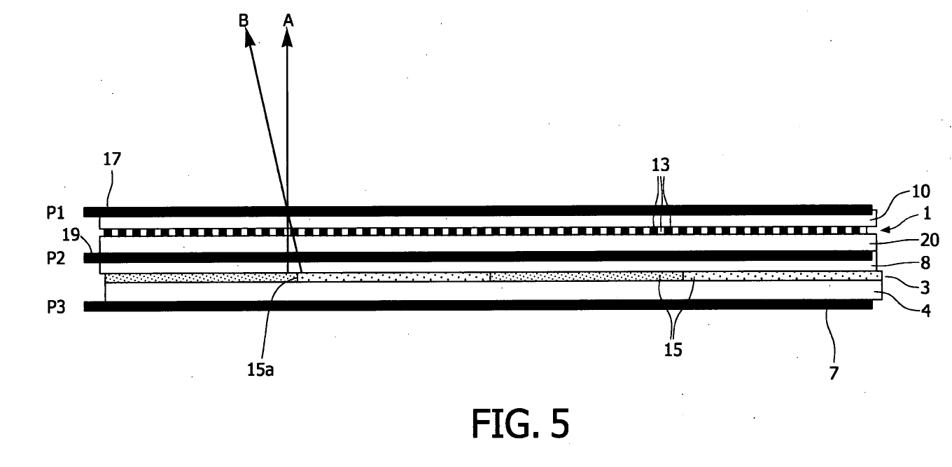

FIG. 5 is a schematic cross-sectional view illustrating the structure of a liquid crystal display according to an exemplary embodiment of the present invention;

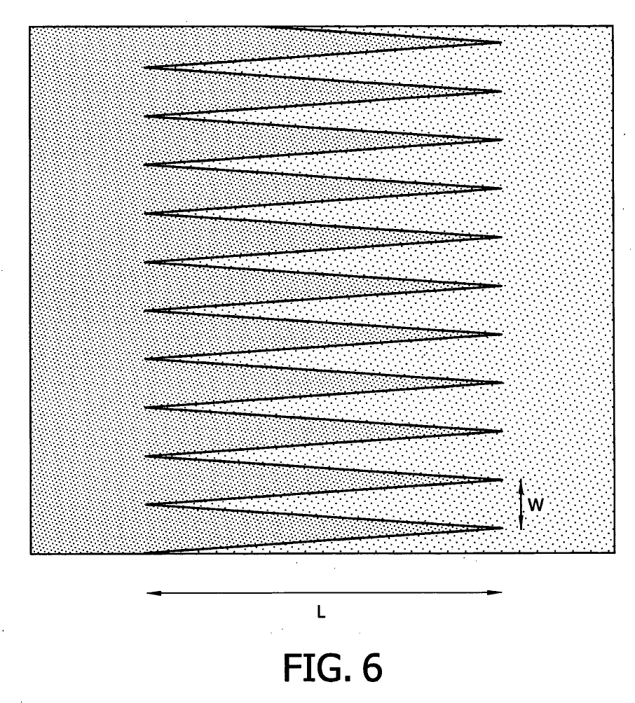

FIG. 6 is a schematic illustration of the gradual transition between neighboring picture elements of the second liquid crystal display panel according to an exemplary embodiment of the present invention using the twisted nematic (TN) effect;

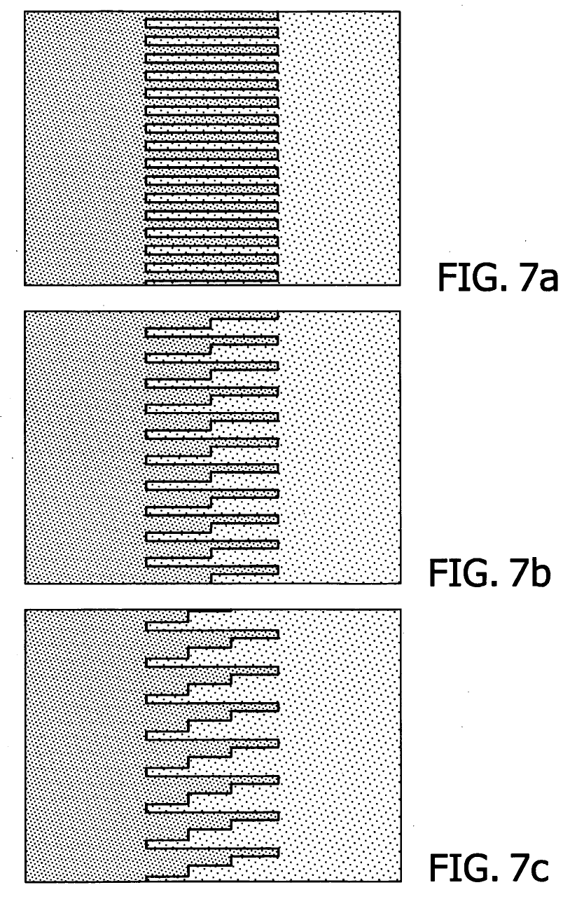

FIGS. 7a-7c are schematic illustrations of the gradual transition between neighboring picture elements of the second liquid crystal display panel according to another exemplary embodiment of the present invention using the TN effect;

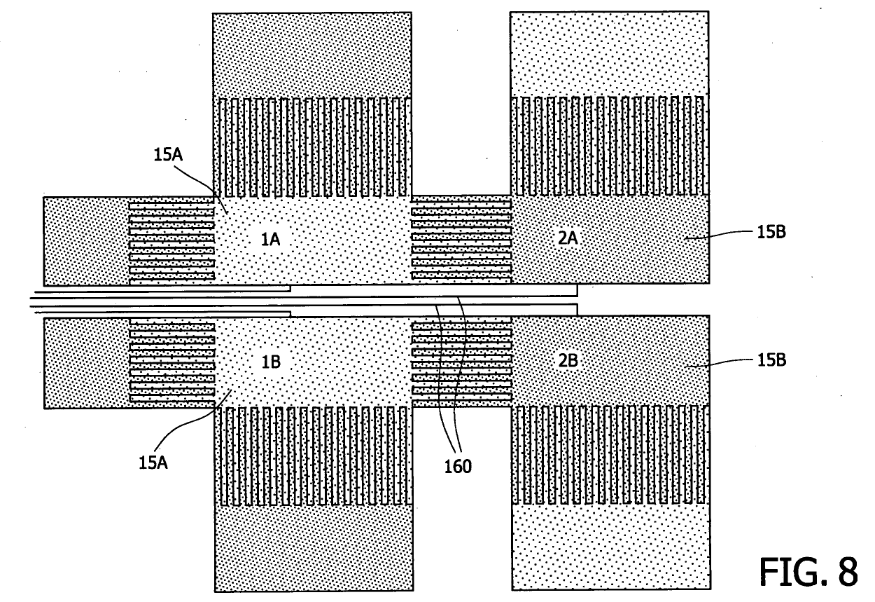

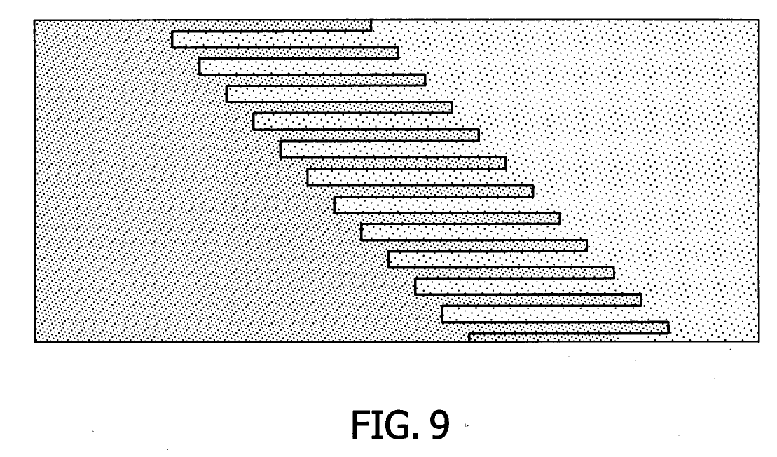

FIG. 8 is a schematic illustration of the gradual transition between neighboring picture elements of the second liquid crystal display panel according to another exemplary embodiment of the present invention using the TN effect;

FIG. 9 is a schematic illustration of the gradual transition between neighboring picture elements of the second liquid crystal display panel according to yet another exemplary embodiment of the present invention using the TN effect;

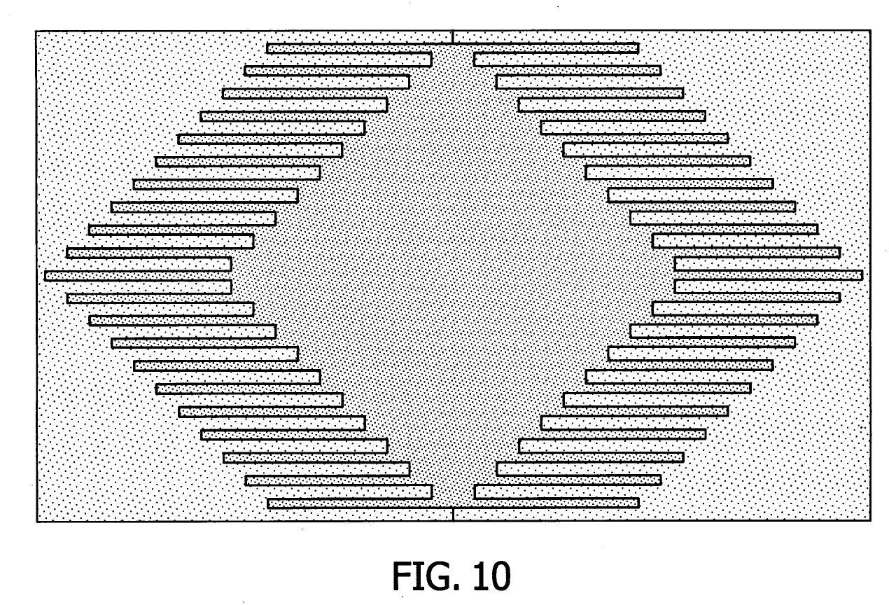

FIG. 10 is a schematic illustration of the configuration of the picture elements of the second liquid crystal display panel in an in-plane switching arrangement according to an exemplary embodiment of the present invention;

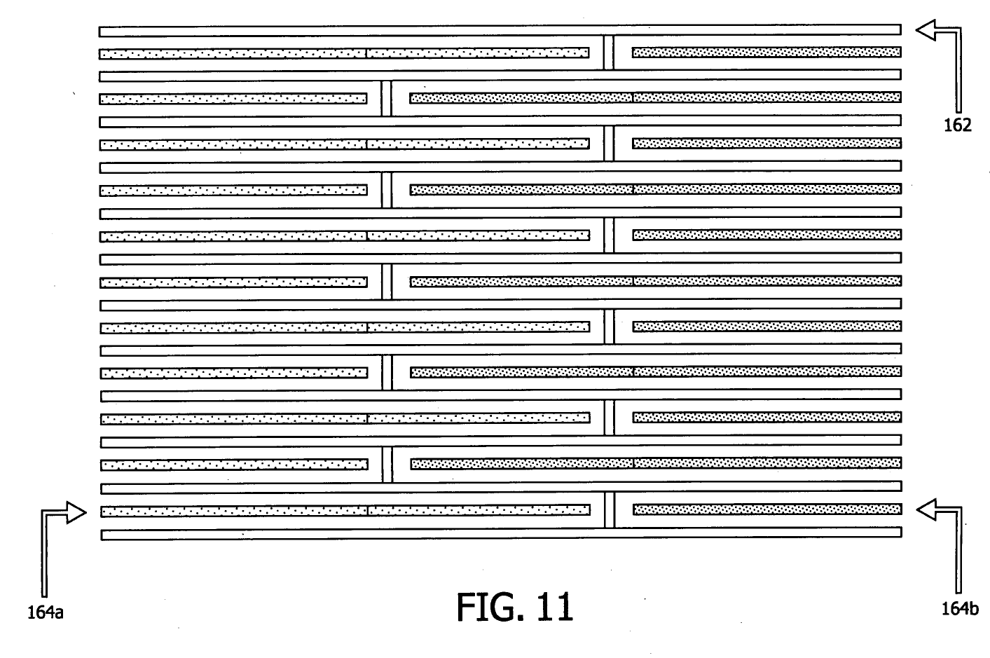

FIG. 11 is a schematic illustration of the configuration of the picture elements of the second liquid crystal display panel in an in-plane switching arrangement according to an exemplary embodiment of the present invention;

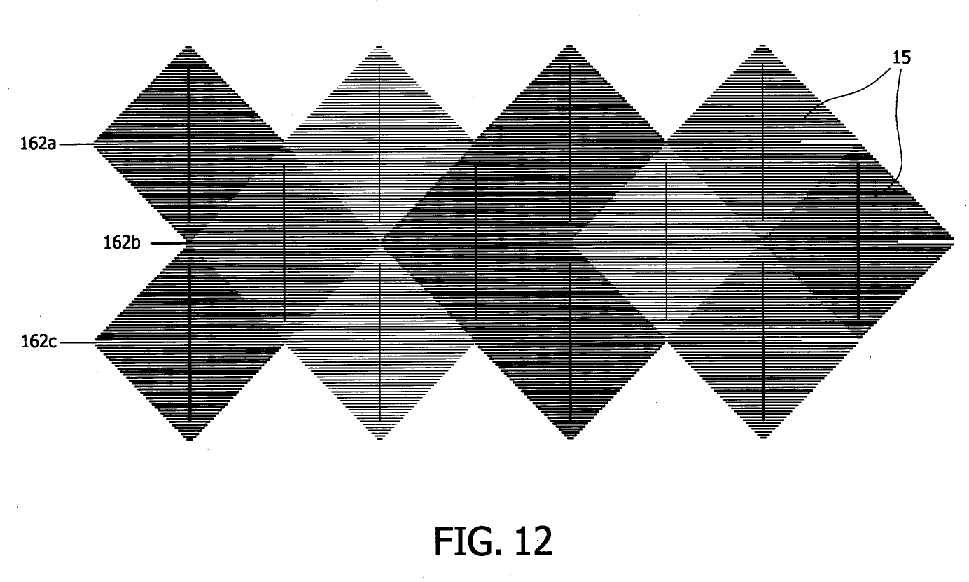

FIG. 12 is a schematic illustration of the configuration of the picture elements of the second liquid crystal display panel in an in-plane switching arrangement according to another exemplary embodiment of the present invention;

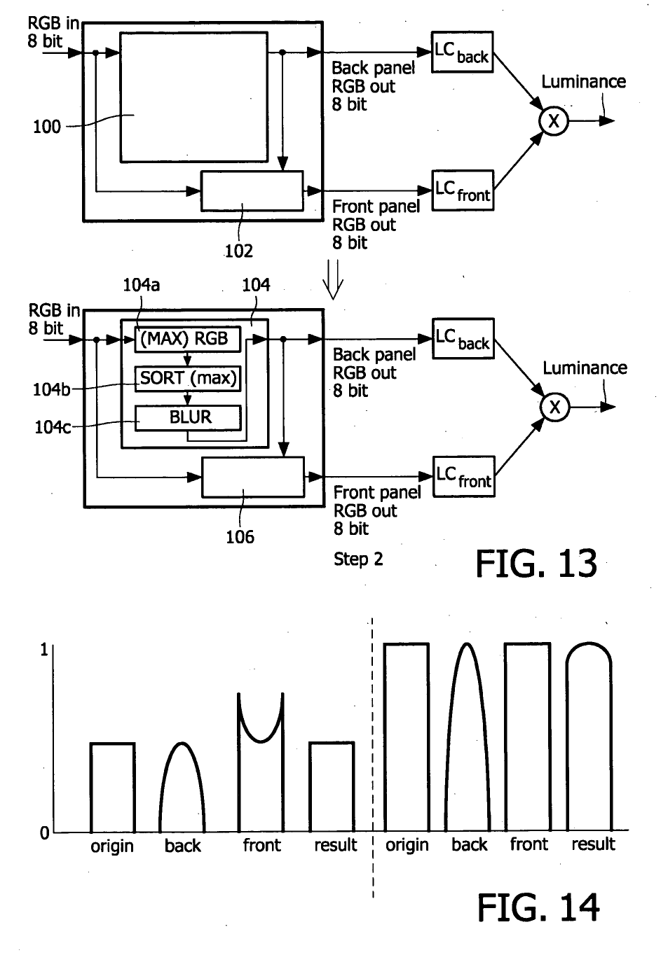

FIG. 13 is a schematic flow diagram illustrating the principal steps of an image processing technique employed by a system according to another exemplary embodiment of the present invention; and

FIG. 14 is a schematic graphical illustration showing scaling problems for high greyscale values (255, or transmission of 1) it can be seen that the necessary compensation for these high greyscale values by the front panel as indicated by the dotted line (right-hand side of the Figure) is not possible.

In order to create a simple LCD, and referring to FIG. 1 of the drawings, we start with two pieces of polarized glass 10, 20, each comprising a glass plate having a polarizing film on one surface thereof. Microscopic grooves are formed on the opposite surface of each glass plate 10, 20, which grooves are in the same direction as the polarizing film. A coating 30 of nematic liquid crystals 40 is then applied to one of the glass plates 10. It should be noted here that one feature of liquid crystals is that the orientation of the molecules is affected by electric field. A particular sort of nematic liquid crystal, called twisted nematics (TN), is naturally twisted. A electric field over these liquid crystals will untwist them to varying degrees, depending on the voltage. Thus, LCDs tend to use these liquid crystals because they react predictably to electric current in such a way as to control light passage.

Referring back to FIG. 1 of the drawings, the coating 30 of nematic liquid crystals 40 is applied to the glass plate 10, on the surface having the above-mentioned grooves therein. These grooves will cause the first layer of molecules 40 of the liquid crystal coating 30 (i.e. the layer of molecules adjacent the surface of the glass plate 10) to align with the orientation of the grooves and the polarizing film. The second glass plate 20 is then added, such that the liquid crystal coating 30 is sandwiched between the surfaces of the glass plates 10, 20 having the above-mentioned grooves therein, with the orientation of the grooves and the polarizing film of the second glass plate 20 being at right angles to that of the first glass plate 10. As before, the grooves of the second glass plate 20 will cause the layer of the molecules 40 adjacent thereto to align with the orientation of the respective polarizing film. Each successive layer of TN liquid crystal molecules 40 will gradually twist between the orientation of the layer of molecules 40 adjacent the surface of the first glass plate 10 and the orthogonal orientation of the layer of molecules 40 adjacent the surface of the second glass plate 20.

In the absence of an electric charge being applied to the liquid crystal molecules 40, as light 50 strikes the first polarizer 10, it is polarized accordingly. The molecules 40 in each layer of the coating 30 then guide the light they receive to the next layer. As the light passes through the liquid crystal layers, the molecules 40 also change the light's plane of vibration to match their own angle. When the light reaches the far side of the liquid crystal coating 30, it vibrates at the same angle as the final layer of molecules 40 (adjacent the surface of the second glass layer 20). If the final layer of molecules 40 is aligned with the polarizing film of the second glass plate 20, then the light 50 will pass through. However, if an electric charge is applied (via electrodes 60) to the liquid crystal molecules 40, they “untwist” and, as the configuration straightens out, so the liquid crystal molecules change the angle of light passing through them so that it no longer matches the angle of the second polarizer 20. Consequently, no light can pass through that area of the LCD, making that area darker than surrounding areas of the display.

Current high resolution LCD displays employ active matrix addressing.

Active matrix LCDs depend on electronics components arranged in each pixel, in particular thin film transistors (TFTs) and storage capacitors. They are arranged in a matrix on one of the glass plates 10, 20. In order to address a particular pixel 90, the proper row 70 is switched on, and then a charge is sent down the correct column 80. Since all of the other rows 70 that the column 80 intersects are turned off, only the capacitor at the designated pixel 90 receives the charge. The capacitor is able to hold the charge until the next refresh cycle, and if the amount of voltage supplied to the liquid crystal is carefully controlled, then it can be made to “untwist” only enough to allow some light through. By doing this in very exact, very small increments, LCDs can create a greyscale, and most conventional LCDs offer 256 levels of brightness per pixel.

Referring to FIG. 2 of the drawings, an LCD that can show color must have three sub-pixels 100 with respective red, green and blue color filters to create each color pixel 90. Through the careful control and variation of the voltage applied, the intensity of each subpixel 100 can range over 256 shades. Combining the sub-pixels produces a possible palette of 16.8 million colors (256 shades of red×256 shades of green×256 shades of blue). In monochrome medical LCD displays the color filters is omitted and a pixel is built up from 3 individually addressable sub-pixels.

It is an object of the present invention to provide a liquid crystal display having increased contrast and brightness relative to prior art arrangements.

One approach to achieving this object was proposed by Seetzen, Helge and Whitehead, Lorne A. “P.54.2: A High Dynamic Range Display Using Low and High Resolution Modulators”, SID 03 DIGEST, in which it is proposed to apply a segmented backlight to illuminate the LCD in accordance with image content. In this way, the dynamic range of the display is increased, and especially very small contrasts over short distances can be displayed better. The strength of the concept is therefore well-matched with the requirements for diagnostic X-ray imaging. The resolution of the backlight pixels is coarse with respect to the LCD pixels. Due to the large size of the backlight pixels, maximum contrast can only be achieved over larger distances. However, as the human eye has limited contrast over small distances, this limitation can be made invisible. The proposed arrangement uses a backlight based on light emitting diodes (LEDs). However, the required high-brightness LEDs are expensive, and each have slightly different characteristics. Thus, it is hard to achieve uniformity, and cost may also be an issue. The other proposal is to use an LCD projector as a segmented backlight, which results in (very) deep displays, which is not acceptable. Moreover, in order to achieve sufficient brightness, the light is collimated, which results in a small viewing zone.

In accordance with the following exemplary embodiment of the present invention, the object is achieved by providing a second liquid crystal structure between the backlight and the main LCD panel. In a preferred embodiment, this second liquid crystal structure has only a limited number (say, 500-2000) of large (say, 5-20 mm) pixels. Thus, referring to FIG. 3 of the drawings, a liquid crystal display comprises a liquid crystal display panel 1 having a structure such as that described with reference to FIGS. 1 and 2, and an LCD backlight 2 comprising, for example, a direct-lit backlight provided by fluorescent discharge tubes. The brightness of the backlighting is preferably relatively very high compared with consumer type LCD systems.

Located between the liquid crystal display panel 1 and the backlight 2, there is provided a second liquid crystal structure 3. The structure 3 comprises a first glass plate 4 divided into segments or “pixels” 15 by means of rows and columns of transparent conductive material. Each of these pixels 15 is connected via an electrode 6 to an external integrated circuit (not shown) for controlling the charge applied to each pixel 5. A polarizer 7 is provided between the backlight 2 and the surface of the glass plate 4 opposite the surface carrying the pixels 5. In the example shown, the polarizer is connected to the glass plate 4 (perhaps in the form of a polarizing film or the like), but this is not essential. A second glass plate 8 is provided, the two glass plates 4, 8 being sealed together, with a small gap 11 (e.g. 1-20 microns) therebetween. This gap 11 is filled with a liquid crystal material. The second glass plate 8 is covered with an unpatterned transparent electrode 9 (see additionally FIG. 4 of the drawings) facing the first glass plate 4.

By changing the voltage over a given segment or pixel 15 (by means of, for example, a passive matrix scheme), the polarization of the light traversing the segment or pixel 5 can be changed, such that the amount of light passing through the selection polarizer (on glass plate 10 of the liquid crystal panel 1) can be changed. Thus, in respect of darker portions of the image to be displayed on the LCD panel 1, a charge is applied to corresponding segments 5 of the second liquid crystal structure 3 so as to reduce the amount of light, or even prevent all light, passing through those segments 5 to the liquid crystal display panel 1. In a monochrome medical LCD arrangement, the introduction of the second liquid crystal structure 3 has been shown to improve the black level from 1.3 nit to 0.02 nit, and the white level was only slightly decreased from 1000 nit to 750 nit, such that the maximum contrast was increased from 770 to the order of 25000.

The additional liquid crystal layer reduces the brightness level of the dark portions of the image displayed on the LCD panel. The enhanced output power of the backlight increases the brightness value of the bright portions of the displayed image. As a result, the dynamic range of the liquid crystal display is increased relative to the prior art.

It will be appreciated that the present invention is suitable for increasing contrast in all types of LCD system, including (but not limited to) monochrome LCD displays for medical imaging, including X-ray diagnostics, high-end (color) LCD-television/multi-media displays, and everything in between. The advantages of this approach relative to prior art schemes for increasing contrast in an LCD system, include cost: the second liquid crystal structure and the electronics required to drive it can be very simple components based on existing mass products, as can be the fluorescent discharge tubes or other backlighting means; and uniformity: liquid crystal displays can be made very uniformly, as can fluorescent discharge tubes or other suitable backlighting means.

Referring to FIG. 5 of the drawings, a liquid crystal display according to an exemplary embodiment of the present invention comprises the first and second glass plates 10, 20, with a layer of liquid crystal material therebetween defining the relatively small pixels 13 of the upper LCD panel 1. The second LCD structure 3 is provided by the third glass plate 4 and the fourth glass plate 8 with a layer of liquid crystal material therebetween defining the relatively large pixels 15 of the lower LCD panel. A first polarizer 17 is provided on the first glass plate 10, a second polarizer is provided on the second glass plate 20 (between the first and second LCD panels 1, 3) and a third polarizer 7 is provided on the third glass plate 4, as shown. Because of the layers 19, 20 between the second LCD panel 3 and the first LCD panel 1, the big pixels 15 of the second LCD panel, having sharp edges, become visible when the viewing angle towards the display is changed, as a result of parallax. Parallax is defined as the apparent difference in the position or direction of an object when it is viewed from two different points, so with reference to FIG. 5, the edge 15a of one of the big pixels of the second LCD panel 3 is not visible when the display is viewed from point A, but it becomes visible when the display is viewed from point B. This is obviously undesirable.

Therefore, in order to alleviate this problem, in accordance with a preferred embodiment of the present invention, the pixels 15 of the second liquid crystal display panel 3 partially overlap and neighboring pixels are interweaved in the overlap area to create a gradual transition from one pixel to the next. Referring to FIG. 6 of the drawings, this gradual transition may be in the form of substantially triangular comb teeth. With a typical thickness of the glass plate 8 of 0.7 mm, the overlap area or “mixing zone” of the picture elements is typically 2 mm. More generally, the length L of the comb teeth might be 0.5 to 5 mm (say, 2 mm typically) and the width W might be 1-300 microns (say 0.1 mm typically). However, it will be appreciated that the width of the overlap area will be dependent on the thickness of the glass plate of the LCD panel, in the sense that the thicker the glass plate, the wider will the overlap area need to be.

Referring to FIGS. 7a to 7c of the drawings, the perceived intermediate grey values between adjacent pixels is achieved using rectangles, the length of which might be typically 2 mm and the typical width might be 10-20 microns.

Referring to FIG. 8 of the drawings, in another exemplary embodiment (one-mask design) of the present invention, adjacent pixels 15A and 15B might be split into two parts A, B with electrodes 160 therebetween.

The embodiments illustrated in FIGS. 9 and 10 of the drawings shows the gradual transition between adjacent pixels being at a substantially 45 degree angle, which is particularly convenient when the 2^{nd} LCD is of an in-plane-switching type.

FIG. 11 illustrates an in-plane switching overlapping configuration of an exemplary embodiment of the present invention, showing a common electrode 162 and first and second electrodes 164a, 164b corresponding to first and second respective adjacent pixels.

FIG. 12 shows the pixel layout of another in-plane switching configuration, in which the relatively large pixels 15 of the second liquid crystal display panel (which may be of the order of 10×10 mm) are tilted at 45 degrees (with the mixing or gradual transition referred to above not shown). The complete pixel area may be, for example, of the order of 10×10 cm. The embodiment shown is a one-mask design with pixels 15 split by electrodes 162a, 162b, 162c. A three-mask design is also envisaged, with transparent electrodes below a transparent isolator. It will be appreciated that the number of electrodes 162 used per pixel dictates the number of intermediate values between pixels and therefore the degree of graduation of the transition therebetween.

In an alternative exemplary embodiment, and referring to FIG. 13 of the drawings, first, the backpanel image is calculated (step 100) and then the frontpanel image is calculated (step 102) by dividing the original image by the calculated backpanel image. All processing steps are done on a subpixel level. In step 1, an RGB image with 8 bits per subpixel is input, thus in total 24 bits (more generally every image is converted into a 24 bit bitmap (bmp) image). However, this is just intended to illustrate an exemplary image processing sequence. In principle, also 10 bit data or higher or different file formats could be processed in a similar manner. Moreover, for a final product, the algorithm should ideally not only work on static images but also on motion content and even for the complete desktop. It is likely that the algorithm may then be implemented into the hardware of either the graphics card of the PC that drives the monitor, or as a dedicated part of the electronics of the display itself.

In a first exemplary embodiment, in respect of a greyscale monitor, the display consists of a backlight, a first, greyscale LCD (front)panel, and a second, greyscale, (back)panel. Color images that are offered to this display are converted to a greyscale image in the following way: for each pixel, the maximum value of the three red, green and blue subpixels is taken and copied to each of the three subpixels (see step 104a in FIG. 13): if a certain RGB pixel has the greyvalues (10,40,35), the new RGB pixel becomes (40,40,40). This is done for all pixels in the image, so that all color information is removed and only the luminance information per pixel remains. This then corresponds to a greyscale image. Original greyscale images are offered as is, and are not changed by this maximizing algorithm.

In a second exemplary embodiment, in respect of a color monitor, the display consists of a backlight, a first, greyscale, LCD (front)panel, and a second, color, (back)panel. Now also color images are offered as is, and no maximizing algorithm is performed. In this way color images can be displayed as well.

FIG. 13 shows that after the splitting with a square root (or other splitting algorithm) a blurring algorithm is used on the backpanel image (step 104c). This is done to avoid the parallax problem as already stated above. By blurring, one effectively lowers the resolution of the backpanel such that the light that hits the frontpanel is more diffuse. As a result, it seems as if the light that is illuminating a single pixel of the frontpanel comes from a broader area. If one now looks from oblique angles to the display the parallax is avoided as no sharp backpanel image can be seen anymore.

The blurring can be performed by applying a Gaussian shaped filter across a certain pixel range. At this moment we use a pixel range of 5×5 pixels for a 1.3 Megapixel display (1280×1024). Depending on the image content and target application another range can also be used and will generally be in the range of 3×3 up to 20×20 pixels. Moreover, for higher resolution panels with smaller pixel pitches, such as for mammography commonly used 5 Megapixel display (2560×2048), the range should generally be larger. Currently we use a range of 10×10 for this resolution display. In fact the blurring distance should roughly be equal to the distance between the two LC materials layers, i.e. equal to the total thickness of the two intermediate glass plates. This distance typically is on the order of 2 mm, so the blurring range in ‘pixels×pixels’ should also be typically 2 mm and can be determined once the pixel pitch is known. In formula:

$${r}_{blur} = \frac{d}{p} ,$$

where r_{blur} is the blurring range in (number of pixels)×(number of pixels, e.g. 5×5), d is the distance between the two LC material layers, and p is the pixel pitch of the panel. For example a distance of 2 mm and a pixel pitch of 0.28 mm would mean a blurring range of roughly 7×7 pixels. This formula only gives an indication. The optimal blurring range should be determined in an actual working environment such that the influence of application area (e.g. mammography, cardiovascular, . . . ), image content and ambient conditions (light settings) can be taken into account.

What counts in the end, is that the parallax is not perceived anymore and the blurring range has to be adjusted accordingly to reach this demand.

If the blurring range is too small (1×1 corresponds to a sharp image) one risks the appearance of the parallax, if the range is too high, the gain in contrast is not very large. The sharpness of the final perceived image depends on the frontpanel, the perceived contrast is largely determined by the backpanel.

In a specific exemplary embodiment of the blurring algorithm, the blurring is actually performed in five steps:

(1) The image is divided in blocks of a certain size; the blurring range.
(2) Within this block, the maximum luminance value) or greyscale value) is searched. This will be the maximum value within this block after the blurring has been performed and this value will also be placed in the center of the block. In the present prototype we use a Gaussian filter as a blurring filter. In formula:

$$L ( i , j ) = {L}_{max , block} \cdot e \frac{( - {i}^{2} - {j}^{2} )}{{r}^{2}} ,$$

where L(i,j) is the new luminance level in the i^{th} and j^{th} subpixel, L_{max,block} is the maximum subpixel value within the block, and r is the total blocksize, given in the number of pixel. Since every pixel has three subpixels, i and j take values between −3*r and +3*r.
(3) To reduce the number of artefacts in the perceived image care is taken that:
(a) The difference in the new luminance values between neighboring pixels is not higher than a certain threshold.
(b) The difference in the new luminance values between the neighboring blocks is not higher than a certain threshold.
(4) If the difference in step (3) is higher, the threshold value is subtracted from the highest of the two values under comparison, such that the difference is then below the threshold. The threshold value may depend on ambient conditions, the targeted application for the display, or the image content, but should be chosen such that the effects of blurring are not perceived by the eye.
(5) After blurring of the backpanel image, the frontpanel image can be calculated (step 106). The original image is divided by the calculated backpanel image and this result is then scaled with a lookup table such that the total perceived image corresponds to the DICOM standard, or to any other preferred display function or gamma. The frontpanel image is automatically sharpened in this way.
Other embodiments for blurring:
The blurring of the background image can actually be done in a number of ways:

The straightforward method, by just averaging all luminance values within a block, works but can result in some artefacts.

Also other filters than Gaussian filter as described in the embodiment above can be applied. Instead of using Gaussian shaped profiles we can also use triangular profiles or flat profiles with Gaussian tails.

Furthermore, we can also only allow the blurring to increase the background image, i.e. we do not blur by averaging the background but by only increasing the brightness of the background image. For example, we can make a Gaussian shaped intensity or grey value profile around each pixel on the background image. If a pixel on the background image has a lower value than this intensity profile, then the blurred image will take the value of this intensity profile instead of the original unblurred (square rooted) value. For each pixel of the unblurred square rooted background image a Gaussian shaped profile should be applied. The height of the Gaussian shape should be unblurred (square rooted) pixel value.

Alternatively to doing the above procedure, it is also possible to first divide the unblurred background image into blocks. The intensity of the blocks should take the intensity of the maximum pixel value of the pixels within the sub block. On each of these sub-block positions we can then place Gaussian (or flat top Gaussian) shaped intensity profiles and compare these profiles in the same way as was done above. In that way the intensity is only increased again.

For a color image, a greyscale backpanel and a color frontpanel may be used. In that case the backpanel should not take the square root of the greyscale image, but instead look at the individual RGB subpixel values and take the maximum of the three and then take a square root. The resulting greyscales are higher than the normal conversion to black and white, especially if a lot of blue colors are present.

Instead of using two panels we can of course also split the image over three panels and then perform the blurring. The blurring on the backmost panel should be the largest. The middle panel should blur an intermediate amount and the frontpanel should not blur at all.

An example of the artefacts that can occur is when full white greyscale values or close to that value are being displayed (for 8 bit displays a value of 255). Both panels are only capable of showing greyscale values from 0 to 255. If both images are sharp and a greyscale value of 255 is to be displayed, this will not present any problems. Both panels just have to display a value of 255, or a maximum transmission of 1, and the perceived image will also have a value of 255. However, in case one blurs the backpanel image across a certain range this value can drop below 255 and hence errors can occur. In principle, this would normally be compensated by the frontpanel image which would display a value larger than 255 at the edges, such that the total transmission across the whole range is maximum again. However, no values larger than 255 can be displayed, so that errors remain at the edges (as shown in FIG. 14). This problem can be solved by downscaling the total dynamic range of the original image down to a range of, say, 0 to 240, instead of 0 to 255.

In an alternative exemplary embodiment, the resolution of the back and front panels may be the same, and instead the image shown on the backpanel may be blurred and/or the image shown on the front panel may be sharpened, such that the resolution of the image displayed on the backpanel is lower than that of the image displayed on the front panel.

It will be appreciated by a person skilled in the art that modifications and variations can be made to the described embodiments without departing from the scope of the invention as defined by the claims. For example, in the examples, a direct-lit backlight is suggested (using fluorescent discharge tubes behind the second liquid crystal structure), but other types of backlighting will work equally well. In the exemplary embodiment illustrated in FIG. 4 of the drawings, the patterned glass plate 4 is closer to the backlight side of the device, but it may equally be closer to the display side (with the other glass plate 8 closer to the backlight side). In the illustrated embodiments, the pixels or segments 5 of the second liquid crystal structure are square or rectangular, but other shapes (e.g. triangles, pentagons, hexagons, etc) could also be used. In between the second liquid crystal structure 3 and the LCD panel 1, further optical elements could also be included, such as diffusers or polarizers. Also, one may choose to leave some open space between the liquid crystal display panel 1 and the second liquid crystal structure 3, so as to blur the boundaries of the segments 5. The various polarizers used (on glass plates 10, 20 and 4 in the described embodiment) can be absorbing or reflecting in relation to the rejected polarization, although reflection allows light recycling, thereby increasing system efficiency.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A system for displaying an image on a liquid crystal display comprising a first liquid crystal display panel (1) defining an array of picture elements (13) for displaying an image, backlighting means (2), and a second liquid crystal display panel (3) located between said first liquid crystal display panel (1) and said backlighting means (2), said second liquid crystal display panel (3) defining an array of picture elements (15) for displaying an image, the system being arranged and configured to display at least a portion of said image on each of said first and second liquid crystal display panels (1, 3) such that the resolution of the image displayed on said second liquid crystal display panel (3) being lower than that of the image displayed on said first liquid crystal display panel (1).

2. A system according to claim 1, wherein adjacent respective polarizers of the first and second liquid crystal display panels (1, 3) are aligned.

3. A system according to claim 1, comprising means for dividing said image so that a first portion thereof is displayed on said first liquid crystal display panel (1) and a second portion thereof is displayed on said second liquid crystal display panel.

4. A system according to claim 1, comprising means for blurring the image displayed on said second liquid crystal display panel (3) relative to the image displayed on said first liquid crystal display panel (1).

5. A system according to claim 1, comprising means for sharpening the image displayed on said first liquid crystal display panel (1) relative to the image displayed on said second liquid crystal display panel (3).

6. A system according to claim 1, further comprising means for selectively applying a charge to one or more of the picture elements (15) of said second liquid crystal display panel (3) corresponding to relatively dark portions of said image, so as to at least limit the quantity of light (5) transmitted therethrough to said first liquid crystal display panel (1).

7. A system according to claim 1, wherein said second liquid crystal display panel (3) defines an array of fewer and larger picture elements (15) than that of said first liquid crystal display panel (1).

8. A system according to claim 1, comprising one or more third liquid crystal display panels located between said first and second liquid crystal display panels, said system being arranged and configured to display at least a portion of said image on said one or more third liquid crystal display panels such that the resolution of the image displayed one said one or more third liquid crystal display panels is less than that of the image displayed on the first liquid crystal display panel and/or greater than that displayed in the second liquid crystal display panel.

9. A liquid crystal display comprising a first liquid crystal display panel (1) defining an array of picture elements (13) for displaying an image, backlighting means (2), a second liquid crystal display panel (3) defining an array of picture elements (15) for displaying an image, and a system according to claim 1.

10. A method for displaying an image on a liquid crystal display comprising a first liquid crystal display panel defining an array of picture elements for displaying an image, backlighting means, and a second liquid crystal display panel located between said first liquid crystal display panel and said backlighting means, said second liquid crystal display panel defining an array of picture elements for displaying an image, the method comprising displaying at least a portion of said image on each of said first and second liquid crystal display panels such that the resolution of the image displayed on said second liquid crystal display panel is lower than that of the image displayed on said first liquid crystal display panel.

11. A liquid crystal display according to claim 9, wherein adjacent picture elements (15) of said second liquid display panel (3) at least partially overlap perceptually.

12. A liquid crystal display according to claim 11, wherein neighboring picture elements are interwoven so as to cause said partial perceptual overlap.

13. A liquid crystal display according to claim 12, wherein the gradual transition between said first and second neighboring picture elements (15A, 15B) is in the form of a plurality of comb teeth of varying lengths.

14. A liquid crystal display according to claim 13, wherein said comb teeth are substantially triangular.

15. A liquid crystal display according to claim 9, wherein a charge is selectively applied to the picture elements (13, 15) of said first and/or second liquid crystal display panels (1, 3) via respective electrodes (60).

16. A liquid crystal display according to claim 15, wherein an addressing electrode is provided for each picture element.

17. A liquid crystal display according to claim 15, wherein the electrodes (6) in respect of the picture elements (15) of at lest the second liquid crystal display panel (3) are of a zig-zag or otherwise meandering configuration.

18. A liquid crystal display comprising a first liquid crystal display panel (1) defining an array of picture elements (13) for displaying an image, and backlighting means (2), the display further comprising a second liquid crystal display panel (3) located between said first liquid crystal display panel (1) and said backlighting means (2), said second liquid crystal display panel (3) defining an array of fewer and larger picture elements (15) than that of said first liquid crystal display panel (1), and means for selectively applying a charge to one or more of the picture elements (15) of said second liquid crystal display panel (3) corresponding to relative dark portions of said image, so as to at least limit the quantity of light (5) transmitted therethrough to said first liquid crystal display panel (1).

19. A method of manufacturing a liquid crystal display, comprising providing a first liquid crystal display panel (1) defining an array of picture elements (13) for displaying an image, providing backlighting means (2), providing a second liquid crystal display panel (3) between said first liquid crystal display panel (1) and said backlighting means (2), said second liquid crystal display panel (3) defining an array of fewer and larger picture elements (15) than that of said first liquid crystal display panel (1), the method further comprising providing means for selectively applying a charge to one or more of the picture elements (15) of said second liquid crystal display panel (3) corresponding to relatively dark portions of said image, so as to at least limit the quantity of light (5) transmitted therethrough to said first liquid crystal display panel (1).

20. Apparatus for driving a liquid crystal display according to claim 9, comprising means for selectively applying a charge to one or more of the picture elements (15) of said second liquid crystal display panel (3) corresponding to relatively dark portions of said image.

21. A method of driving a liquid crystal display according to claim 9, comprising selectively applying a charge to one or more of the picture elements (15) of said second liquid crystal display panel (3) corresponding to relatively dark portions of said image.
